(19) United States
(12) Patent Application Publication
(10) Pub. No.: US 2025/0147239 A1
(43) Pub. Date: May 8, 2025

(54) COMPACT OPTICAL BEAM COMBINER PACKAGE

(71) Applicant: Raytheon Company, Tewksbury, MA (US)

(72) Inventors: Anthony D. Dichiara, McKinney, TX (US); David R. McCormick, Celina, TX (US); Dustin R. Thielen, Rainier, WA (US)

(21) Appl. No.: 18/816,799

(22) Filed: Aug. 27, 2024

Related U.S. Application Data
(60) Provisional application No. 63/597,138, filed on Nov. 8, 2023.

(51) Int. Cl. G02B 6/293

(52) U.S. Cl. CPC G02B 6/29362

(57) ABSTRACT

An apparatus includes a dichroic combiner array configured to combine multiple input optical beams and generate an output optical beam. The dichroic combiner array includes multiple mirrors and multiple dichroic filters. A first mirror is configured to reflect a first input optical beam towards a first dichroic filter, which is configured to combine the first input optical beam and a second input optical beam. A second mirror is configured to reflect a combined optical beam from the first dichroic filter to a second dichroic filter. A last dichroic filter is configured to generate the output optical beam. The apparatus also includes a beam dump array having multiple beam dumps configured to terminate stray optical energy. The stray optical energy includes at least one of: (i) optical energy reflecting from at least one of the dichroic filters and (ii) optical energy transmitted through at least one of the dichroic filters.

### CROSS-REFERENCE TO RELATED APPLICATION AND PRIORITY CLAIM

This application claims priority under 35 U.S.C. § 119 (e) to U.S. Provisional Patent Application No. 63/597,138 filed on Nov. 8, 2023, which is hereby incorporated by reference in its entirety.

### TECHNICAL FIELD

This disclosure relates generally to optical systems. More specifically, this disclosure relates to a compact optical beam combiner package.

### BACKGROUND

Various optical systems generate multiple optical beams and combine the optical beams in order to produce higher-power output beams. For example, various laser systems have been developed that generate and combine multiple laser beams in order to produce higher-power output laser beams. As a particular example, multiple laser diodes or other laser sources may be used to generate multiple laser beams, and the laser beams may be reflected from or transmitted through various optical devices in order to combine the laser beams.

### SUMMARY

This disclosure relates to a compact optical beam combiner package.

In a first embodiment, an apparatus includes a dichroic combiner array configured to combine multiple input optical beams and generate an output optical beam. The dichroic combiner array includes multiple mirrors and multiple dichroic filters. A first of the mirrors is configured to reflect a first of the input optical beams towards a first of the dichroic filters. The first dichroic filter is configured to combine the first input optical beam and a second of the input optical beams. A second of the mirrors is configured to reflect a combined optical beam from the first dichroic filter to a second of the dichroic filters. A last of the dichroic filters is configured to generate the output optical beam. The apparatus also includes a beam dump array having multiple beam dumps configured to terminate stray optical energy. The stray optical energy includes at least one of: (i) optical energy reflecting from at least one of the dichroic filters and (ii) optical energy transmitted through at least one of the dichroic filters.

Any single one or any suitable combination of the following features may be used with the first embodiment. The dichroic combiner array may be configured to receive n input optical beams. The multiple mirrors may include a collection of n−1 mirrors. The multiple dichroic filters may include a collection of n−1 dichroic filters. The beam dump array may include n beam dumps. The dichroic filters may be collectively configured to generate n−1 combined optical beams, and a final combined optical beam may represent the output optical beam. Here, n may be an integer equal to at least three. The apparatus may also include a manifold configured to provide at least one fluid coolant to the beam dumps and to receive the at least one fluid coolant from the beam dumps. The apparatus may also include a platform configured to carry the dichroic combiner array and the beam dump array and multiple connectors configured to receive the input optical beams. The multiple connectors may be configured to be coupled to multiple optical fibers. The apparatus may also include a housing configured to receive an optical bench including the platform, the dichroic combiner array, and the beam dump array and a cover configured to secure the optical bench in the housing. The apparatus may also include an interface plate configured to be connected to the housing and to an external structure, and the interface plate may include a first port configured to receive at least one fluid coolant and a second port configured to provide the at least one fluid coolant. The beam dumps of the beam dump array may be arranged to allow the stray optical energy to strike the beam dumps at least three times, and the beam dumps may be configured to absorb portions of the stray optical energy during each strike. Each beam dump may include two major surfaces, and the major surfaces of each beam dump may have grooves.

In a second embodiment, a method includes combining multiple input optical beams using a dichroic combiner array to generate an output optical beam. The dichroic combiner array includes multiple mirrors and multiple dichroic filters. A first of the mirrors reflects a first of the input optical beams towards a first of the dichroic filters. The first dichroic filter combines the first input optical beam and a second of the input optical beams. A second one of the mirrors reflects a combined optical beam from the first dichroic filter to a second of the dichroic filters. A last of the dichroic filters generates the output optical beam. The method also includes terminating stray optical energy using a beam dump array having multiple beam dumps. The stray optical energy includes at least one of: (i) optical energy reflecting from at least one of the dichroic filters and (ii) optical energy transmitted through at least one of the dichroic filters.

Any single one or any suitable combination of the following features may be used with the second embodiment. The dichroic combiner array may receive n input optical beams. The multiple mirrors may include a collection of n−1 mirrors. The multiple dichroic filters may include a collection of n−1 dichroic filters. The beam dump array may include n beam dumps. The dichroic filters may collectively generate n−1 combined optical beams, and a final combined optical beam may represent the output optical beam. The method may also include providing at least one fluid coolant to the beam dumps and receiving the at least one fluid coolant from the beam dumps using a manifold. The method may also include mounting the dichroic combiner array and the beam dump array on a platform and using multiple connectors to receive the input optical beams. The multiple connectors may be configured to be coupled to multiple optical fibers. The beam dumps of the beam dump array may be arranged to allow the stray optical energy to strike the beam dumps at least three times, and the beam dumps may be configured to absorb portions of the stray optical energy during each strike.

In a third embodiment, a method includes placing an optical bench in a housing and securing the optical bench within the housing. The optical bench includes a dichroic combiner array configured to combine multiple input optical beams and generate an output optical beam. The dichroic combiner array includes multiple mirrors and multiple dichroic filters. A first of the mirrors is configured to reflect a first of the input optical beams towards a first of the dichroic filters. The first dichroic filter is configured to combine the first input optical beam and a second of the input optical beams. A second of the mirrors is configured to reflect a combined optical beam from the first dichroic filter to a second of the dichroic filters. A last of the dichroic filters is configured to generate the output optical beam. The optical bench also includes a beam dump array having multiple beam dumps configured to terminate stray optical energy. The stray optical energy includes at least one of: (i) optical energy reflecting from at least one of the dichroic filters and (ii) optical energy transmitted through at least one of the dichroic filters.

Any single one or any suitable combination of the following features may be used with the third embodiment. Securing the optical bench within the housing may include placing a cover over the optical bench and connecting the cover to the housing. The method may also include connecting an interface plate to the housing, and the interface plate may also be configured to be connected to an external structure. The interface plate may include a first port configured to receive at least one fluid coolant and a second port configured to provide the at least one fluid coolant. The beam dumps of the beam dump array may be arranged to allow the stray optical energy to strike the beam dumps at least three times, and the beam dumps may be configured to absorb portions of the stray optical energy during each strike.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIGS. 1A and 1B illustrate an example optical bench according to this disclosure;

FIGS. 2A through 2C illustrate an example compact optical beam combiner package according to this disclosure;

FIG. 3 illustrates an example beam dump arrangement in the optical bench of FIGS. 1A and 1B and the compact optical beam combiner package of FIGS. 2A through 2C according to this disclosure; and

FIG. 4 illustrates an example cross-section of beam dumps in the optical bench of FIGS. 1A and 1B and the compact optical beam combiner package of FIGS. 2A through 2C according to this disclosure.

### DETAILED DESCRIPTION

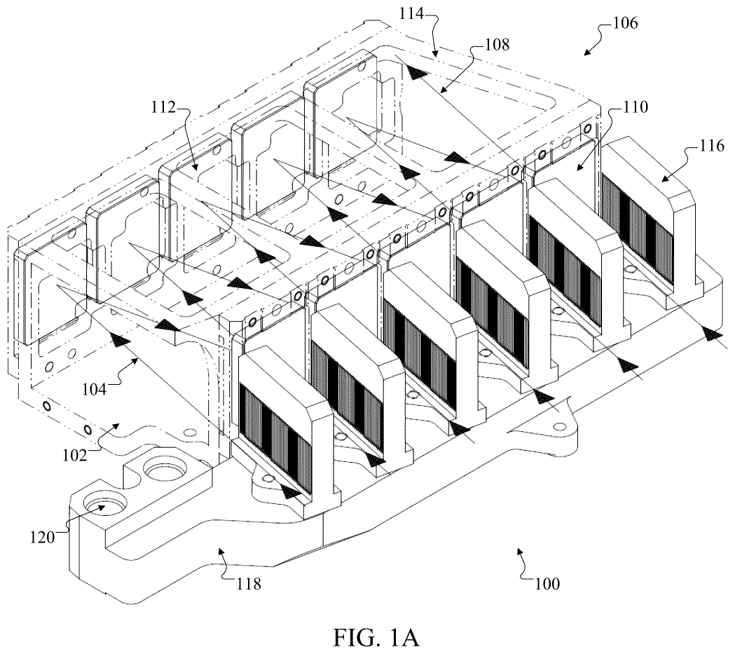

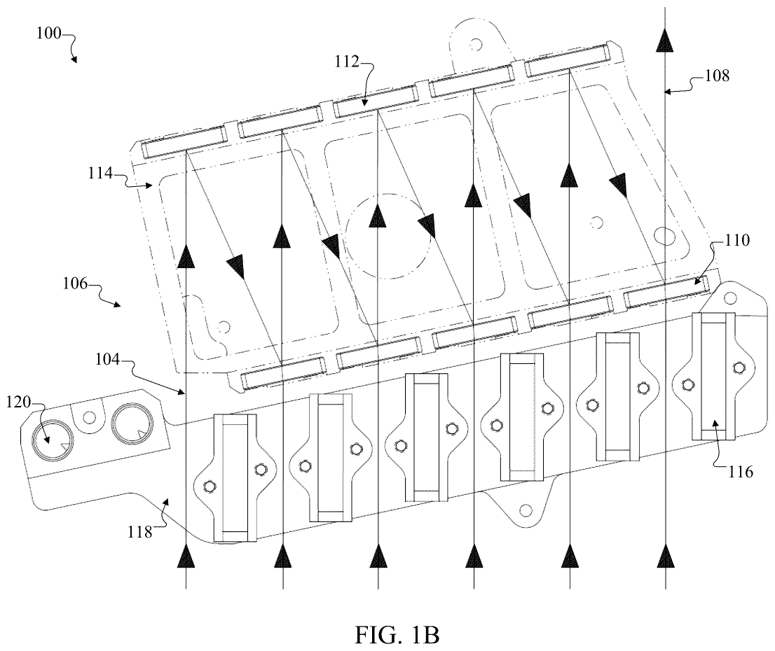

FIGS. 1A through 4 described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, various optical systems generate multiple optical beams and combine the optical beams in order to produce higher-power output beams. For example, various laser systems have been developed that generate and combine multiple laser beams in order to produce higher-power output laser beams. As a particular example, multiple laser diodes or other laser sources may be used to generate multiple laser beams, and the laser beams may be reflected from or transmitted through various optical devices in order to combine the laser beams.

Unfortunately, some applications may desire or require the use of a relatively large number of optical sources and the combination of a relatively large number of optical beams. However, this may require the use of a large number of optical devices that occupy a large amount of space, which increases the size, weight, and power (SWaP) of the resulting optical systems. Also, optical losses are often a concern in these types of optical systems since optical losses can reduce the total amount of optical power available for use. In addition, stray optical energy is typically terminated in order to prevent the stray optical energy from striking and damaging components of the optical systems, and terminating the stray optical energy can lead to thermal management issues in the optical systems.

This disclosure provides a compact optical beam combiner package. As described in more detail below, a compact optical beam combiner package includes multiple inputs that are configured to receive multiple input optical beams. In some cases, for example, the multiple inputs may be configured to receive multiple laser beams, such as multiple laser beams to be combined in order to produce a high-energy laser (HEL) beam or diagnostic/imaging beams. The multiple inputs may include or be associated with multiple input mirrors that reflect the input optical beams. The compact optical beam combiner package also includes a dichroic combiner array, which includes multiple high-reflectance mirrors and multiple dichroic filters. The dichroic filters are configured to combine the input optical beams, where a final one of the dichroic filters is configured to produce an output optical beam. A first high-reflectance mirror is configured to reflect a first input optical beam towards a first dichroic filter. Each subsequent high-reflectance mirror is configured to reflect a combination of an additional input optical beam and at least one prior input optical beam towards a subsequent dichroic filter. A beam dump array in the compact optical beam combiner package includes multiple beam dumps, which are configured to terminate stray optical energy within the compact optical beam combiner package. For instance, the multiple beam dumps may be positioned between the dichroic combiner array and the input mirrors that reflect the input optical beams towards the dichroic combiner array, such as adjacent to the dichroic filters.

In this way, the compact optical beam combiner package can be used to combine multiple optical beams in a package having significantly reduced size and weight. In some cases, for example, the compact optical beam combiner package may be about the size of one and a half shoeboxes, although other sizes may be achieved depending on the implementation. This can provide significant reductions in both volume and mass of the compact optical beam combiner package and can achieve a low profile. Moreover, the compact optical beam combiner package can be designed to reduce or minimize space while also reducing or minimizing optical losses. For instance, the input optical beams received by the compact optical beam combiner package can already be collimated, and small angles of incidence can be used with the high-reflectance mirrors and the dichroic filters to maintain a small footprint. Further, the beam dumps integrated into the compact optical beam combiner package can be used to effectively capture and terminate stray optical energy, which in some cases may amount to more than 99% of the stray optical energy in the compact optical beam combiner package. Optional fluid cooling or other cooling of the integrated beam dumps can be easily supported in order to remove thermal energy from the beam dumps (if needed). In addition, in some embodiments, the compact optical beam combiner package can be manufactured less expensively and more easily, such as by using manufacturing techniques like additive manufacturing (also known as 3D printing) for one or more components of the compact optical beam combiner package.

The described compact optical beam combiner package may find use in any number of commercial, defense-related, or other applications. For example, the described compact optical beam combiner package may be used in various optical systems that use high-energy lasers. As particular examples, the described compact optical beam combiner package may be used in planes, jets, drones, helicopters, or other fight vehicles or in ground-based or sea-based platforms to direct high-energy laser beams at intended targets. In one example use case, for instance, the compact optical beam combiner package may be used to provide defensive capabilities on various platforms against unmanned aerial vehicles (UAVs), such as drones equipped with explosives or other ordinances. As another particular example, the described compact optical beam combiner package may be used in laser welding equipment or industrial equipment that uses lasers to weld components, cut objects, or perform other functions. In general, the described compact optical beam combiner package is not limited to any specific application or use case.

FIGS. 1A and 1B illustrate an example optical bench 100 according to this disclosure. As shown in FIGS. 1A and 1B, the optical bench 100 generally includes a platform 102, which carries other components of the optical bench 100. For example, the platform 102 may represent a baseplate or other structure to which other components of the optical bench 100 can be mounted or otherwise connected. In some embodiments, the optical bench 100 can represent a stiff component designed to keep optical elements of a system in optical alignment. The platform 102 may be formed using any suitable material(s), such as one or more metals. The platform 102 may also be formed in any suitable manner. In addition, the platform 102 may have any suitable size, shape, and dimensions.

The optical bench 100 is configured to receive multiple input optical beams 104 to be combined by the optical bench 100. Each input optical beam 104 represents a laser beam or other optical beam having optical energy to be combined with other input optical beams. The optical bench 100 may be configured to receive and combine any desired number of input optical beams 104. The optical bench 100 also includes a dichroic combiner array 106, which is configured to combine the input optical beams 104 and generate a combined or output optical beam 108. The output optical beam 108 represents an optical beam that contains the bulk of the optical energy from the input optical beams 104. As shown in FIGS. 1A and 1B, the dichroic combiner array 106 includes multiple dichroic filters 110 and multiple high-reflectance mirrors 112. Each dichroic filter 110 is configured to selectively transmit illumination at one or more wavelengths while reflecting illumination at other wavelengths. Each high-reflectance mirror 112 is configured to reflect illumination received at the high-reflectance mirror 112 back towards one of the dichroic filters 110.

In the arrangement shown in FIGS. 1A and 1B, the first high-reflectance mirror 112 on the left receives the first input optical beam 104, and the first high-reflectance mirror 112 reflects the first input optical beam 104 towards the first dichroic filter 110 on the left. The first dichroic filter 110 also receives the second input optical beam 104. The first dichroic filter 110 reflects the first input optical beam 104 and transmits the second input optical beam 104, thereby creating a first combined optical beam. The second high-reflectance mirror 112 receives the first combined optical beam from the first dichroic filter 110 and reflects the first combined optical beam towards the second dichroic filter 110. The second dichroic filter 110 also receives the third input optical beam 104. The second dichroic filter 110 reflects the first combined optical beam and transmits the third input optical beam 104, thereby creating a second combined optical beam. This process can be repeated any number of times until the last high-reflectance mirror 112 on the right reflects a combined optical beam to the last dichroic filter 110 on the right. The last dichroic filter 110 reflects that combined optical beam and transmits a last one of the input optical beams 104 on the right, thereby creating the output optical beam 108. Note that while certain numbers of components may be assumed here, the “last” high-reflectance mirror 112 may represent the last high-reflectance mirror 112 in an array of high-reflectance mirrors 112, and the “last” dichroic filter 110 may represent the last high-reflectance mirror 112 in an array of dichroic filters 110. In some embodiments, there may be n−1 high-reflectance mirrors 112 and n−1 dichroic filters 110, where n equals the number of input optical beams 104 being combined. Here, n−1 also equals the number of combined optical beams produced by the dichroic filters 110. In particular embodiments, n may be greater than or equal to three, four, fix, six, or other larger integer.

Each dichroic filter 110 represents any suitable structure configured to transmit and reflect illumination at desired wavelengths. In some cases, for example, at least some of the input optical beams 104 have different wavelengths, and at least some of the dichroic filters 110 can be configured to transmit or reflect at those wavelengths (depending on the position of the dichroic filters 110 relative to the input optical beams 104). Each high-reflectance mirror 112 represents any suitable reflective structure configured to reflect an input optical beam or a combined optical beam with low or minimal loss. In this example, a scaffolding 114 can be used to hold the dichroic filters 110 and the high-reflectance mirrors 112 in place, and the scaffolding 114 can be connected to or form a part of the platform 102. In some cases, the dichroic filters 110 can be arranged linearly with respect to one another, and the high-reflectance mirrors 112 can be arranged linearly with respect to one another.

An array of beam dumps 116 is provided in or on the optical bench 100 and is used to capture and terminate stray optical energy within the optical bench 100. Stray optical energy may include optical energy in an input optical beam 104 that is reflected (rather than transmitted) through the associated dichroic filter 110. Stray optical energy may also or alternatively include optical energy in a reflected optical beam from a high-reflectance mirror 112 that is transmitted (rather than reflected) through the associated dichroic filter 110. The beam dumps 116 can be positioned so that this or other stray optical energy can strike the beam dumps 116 and be absorbed by the beam dumps 116. As described below, in some cases, the beam dumps 116 may support a “three bounce” arrangement in which stray optical energy can strike beam dumps 116 at least three times, which can allow the beam dumps 116 to absorb the vast majority of the stray optical energy.

Each beam dump 116 may be formed from any suitable material(s), such as one or more materials that are highly absorptive at the wavelength(s) of the associated stray optical energy. In some embodiments, for example, the beam dumps 116 may include black chrome surfaces. Each beam dump 116 may also be formed in any suitable manner. Further, each beam dump 116 may have any suitable size, shape, and dimensions. For instance, each beam dump 116 may include a central body (such as in the form of a generally rectangular prism) that extends upward from flanges configured to be secured to the platform 102. Various surfaces of each beam dump 116 may also be grooved, such as to increase surface area and/or provide reflection control. In addition, each beam dump 116 may optionally include one or more fluid channels configured to allow at least one cooling fluid (such as one or more liquids or gasses) to flow into and out of the beam dump 116 in order to remove thermal energy from the beam dump 116. In those embodiments, a manifold 118 may be provided for delivering the at least one cooling fluid to and receiving the at least one cooling fluid from the beam dumps 116, where the beam dumps 116 may be connected to the manifold 118 and the manifold 118 may be connected to or form a part of the platform 102. The manifold 118 can include ports 120 for delivering cooler fluid(s) to the manifold 118 and for receiving warmer fluid(s) from the manifold 118.

The optical bench 100 here can include a number of additional components as needed or desired. For example, one or more mirrors can be used to reflect the input optical beams 104 towards the dichroic filters 110 and the high-reflectance mirrors 112, or one or more mirrors can be used to reflect the output optical beam 108 away from the optical bench 100 at a desired location. The positions and the number of mirrors can easily vary based on how the input optical beams 104 and the output optical beam 108 need to be routed. As another example, at least one sensor may be positioned in or on the optical bench 100 in order to capture sensor measurements associated with operation of the optical bench 100, such as a sensor positioned within the dichroic combiner array 106. This sensor may, for instance, represent a photodiode used to monitor the baseline performance of an optical system and look for conditions such as optics failures or power drops that indicate the optical system may not be safe to operate. However, the number and position(s) of the sensor(s) can vary as needed or desired.

Although FIGS. 1A and 1B illustrate one example of an optical bench 100, various changes may be made to FIGS. 1A and 1B. For example, the optical bench 100 here is used to receive and combine six input optical beams 104. However, the optical bench 100 may be used to receive and combine any suitable number of input optical beams 104. Also, various components shown in FIGS. 1A and 1B may be combined, further subdivided, replicated, omitted, or rearranged and additional components may be added according to particular needs. In addition, the relative sizes, shapes, and dimensions of the optical bench 100 and its individual components can easily vary depending on the implementation.

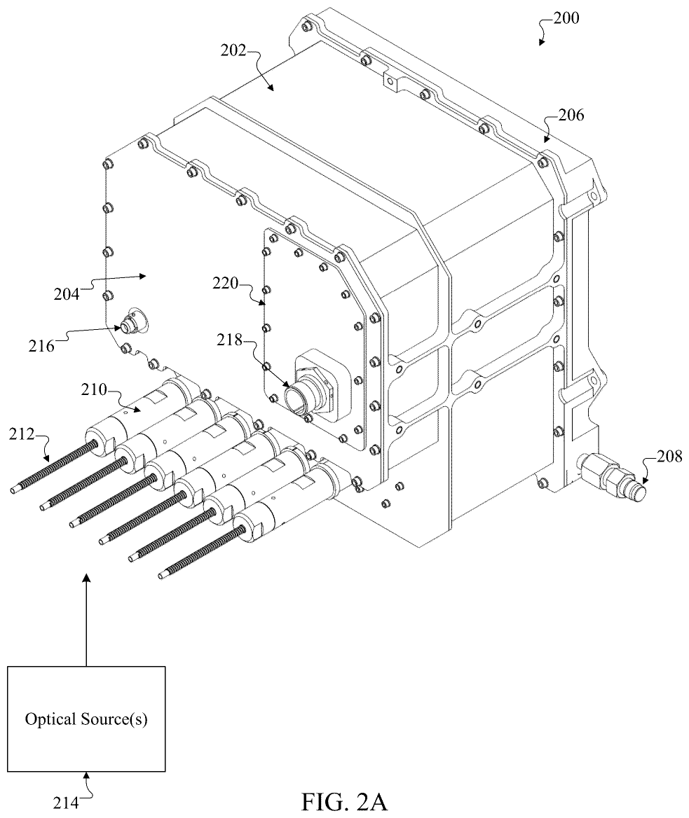

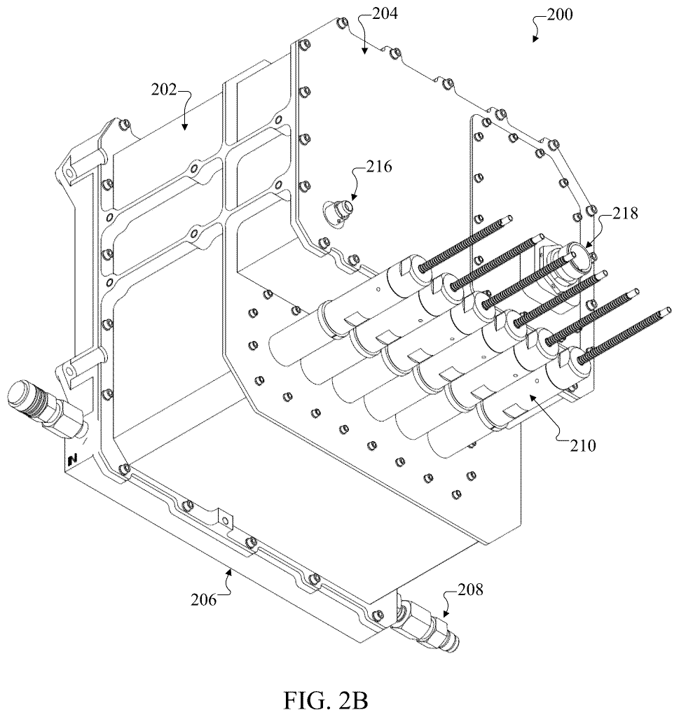

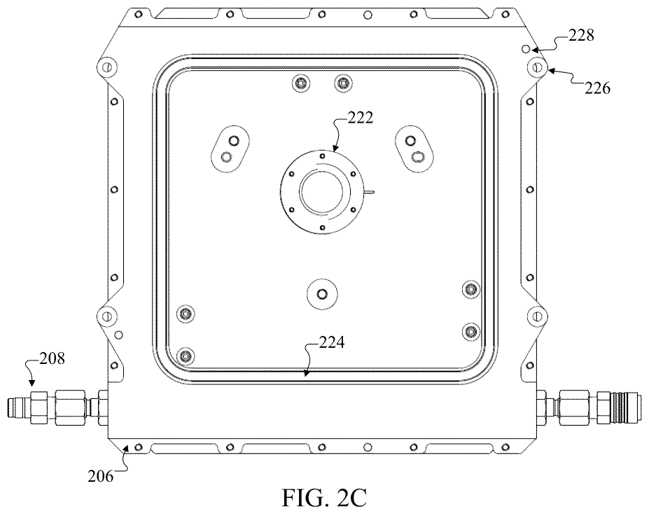

FIGS. 2A through 2C illustrate an example compact optical beam combiner package 200 according to this disclosure. For case of explanation, the compact optical beam combiner package 200 of FIGS. 2A through 2C is described as including the optical bench 100 of FIGS. 1A and 1B. However, the compact optical beam combiner package 200 of FIGS. 2A through 2C may include any other suitable optical bench designed in accordance with the teachings of this disclosure.

As shown in FIGS. 2A through 2C, the compact optical beam combiner package 200 includes a housing 202, which can be used to encase and protect the optical bench 100 and optionally other components of an optical system. The housing 202 can be formed from any suitable material(s), such as one or more metals, and in any suitable manner. The housing 202 can also have any suitable size, shape, and dimensions. A cover 204 can be connected to the housing 202 after the optical bench 100 is positioned within and secured to the housing 202. The cover 204 can be used to secure the optical bench 100 within the housing 202 and to protect the optical bench 100. The cover 204 can be formed from any suitable material(s), such as one or more metals, and in any suitable manner. The cover 204 can also have any suitable size, shape, and dimensions.

In some cases, the housing 202 may be mounted on or otherwise connected to a beam director or other external structure in order to secure the compact optical beam combiner package 200 in place. In other cases, the housing 202 may be mounted on or otherwise connected to an interface plate 206, which represents a structure that can itself be mounted to a beam director or other external structure in order to secure the compact optical beam combiner package 200 in place. In some embodiments, the interface plate 206 may also provide cooling for the compact optical beam combiner package 200. For instance, the interface plate 206 can include multiple ports 208, which allow at least one cooling fluid (such as one or more liquids or gasses) to flow into and out of the interface plate 206 in order to cool the interface plate 206 and remove thermal energy from the compact optical beam combiner package 200.

In this example, the input optical beams 104 are provided to the optical bench 100 within the housing 202 using various types of connectors 210. The connectors 210 may be used to couple various optical fibers 212 (and possibly various types of optical fibers 212) or other waveguides to the platform 102. The type(s) of connectors 210 used here may vary depending on the type(s) of input optical beams 104 being received and/or the type(s) of waveguides providing the input optical beams 104. For instance, smaller connectors 210 may be used with lower-power input optical beams 104, and larger connectors 210 may be used with higher-power input optical beams 104.

In this example, one or more optical sources 214 may be used to provide the input optical beams 104 to the optical bench 100. In some embodiments, the one or more optical sources 214 can be used to provide collimated light as the input optical beams 104 to the optical bench 100, which can help to reduce or minimize optical losses in the optical bench 100. The one or more optical sources 214 include any suitable structure(s) configured to provide multiple input optical beams 104 to be combined, such as multiple laser diodes operating at desired wavelengths.

As can be seen here, a port 216 extends through the cover 204. The port 216 can be used to purge air from an interior space of the compact optical beam combiner package 200. This may be useful, for example, if the interior of the compact optical beam combiner package 200 operates in a vacuum. Also, a connector 218 extends through the cover 204 or through a plate 220 positioned over the cover 204. The connector 218 represents an electronics connector that allows one or more external components (such as an external controller) to be coupled to one or more electrical components within the compact optical beam combiner package 200.

As shown in FIG. 2C, an exit aperture 222 represents an opening through which the output optical beam 108 can be provided. For example, one or more mirrors may be used to direct the output optical beam 108 to the exit aperture 222. A seal 224 may be positioned around a portion of the back side of the interface plate 206. The seal 224 can help to prevent the inflow of gasses, particulates, or other materials. Mounts 226, such as bolts or other connectors, may be used to attach the interface plate 206 to a beam director or other external structure. In this example, there are four mounts 226 in four specific locations of the interface plate 206, although other numbers and arrangements of mounts 226 may be used. Two alignment pins 228 may be used to ensure that the interface plate 206 is mounted in the proper orientation to the beam director or other external structure. In this example, there are two alignment pins 228 in two specific locations of the interface plate 206, although other numbers and arrangements of alignment pins 228 may be used.

An imaginary rectangular prism can be defined around the compact optical beam combiner package 200 and can define the overall profile and size of the compact optical beam combiner package 200. In some embodiments, the rectangular prism has a length (measured left to right facing the cover 204) of about 10.5 inches (about 26.67 centimeters), a depth (measured front to back) of about 8.3 inches (about 21.082 centimeters), a height (measured top to bottom) of about 10.9 inches (about 27.686 centimeters). This gives an overall volume of about 950 cubic inches (about 15,567.71 cubic centimeters). However, these values are for illustration and explanation only and do not limit the scope of this disclosure to a compact optical beam combiner package 200 having any particular size, shape, dimensions, or volumes.

Although FIGS. 2A through 2C illustrate one example of a compact optical beam combiner package 200, various changes may be made to FIGS. 2A through 2C. For example, the compact optical beam combiner package 200 here is used to receive and combine six input optical beams 104. However, the compact optical beam combiner package 200 may be used receive and combine any suitable number of input optical beams 104. Also, various components shown in FIGS. 2A through 2C may be combined, further subdivided, replicated, omitted, or rearranged and additional components may be added according to particular needs. In addition, the relative sizes, shapes, and dimensions of the compact optical beam combiner package 200 and its individual components can easily vary depending on the implementation.

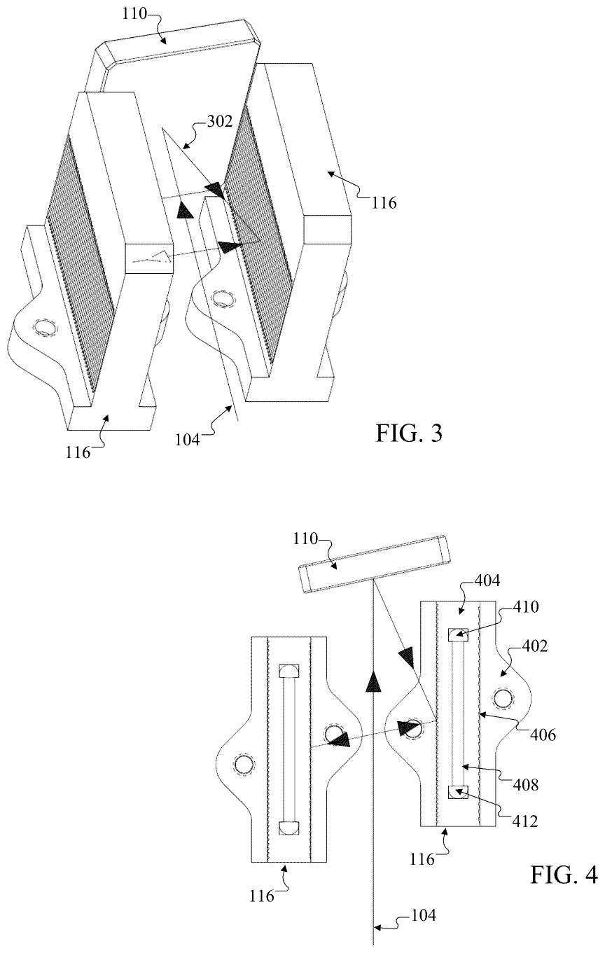

FIG. 3 illustrates an example beam dump arrangement in the optical bench 100 of FIGS. 1A and 1B and the compact optical beam combiner package 200 of FIGS. 2A through 2C according to this disclosure. As shown in FIG. 3, multiple beam dumps 116 are angled relative to an associated dichroic filter 110 but generally parallel with one another. The beam dumps 116 can therefore be positioned at an oblique angle (not parallel or perpendicular) relative to the dichroic filters 110 above the beam dumps 116.

During use, a portion 302 of an input optical beam 104 that reflects from the dichroic filter 110 (rather than being transmitted through the dichroic filter 110) can strike the beam dumps 116, and this portion 302 of the optical beam 104 can be absorbed (terminated) by the beam dumps 116. Here, each beam dump 116 can absorb at least part of the portion 302 of the input optical beam 104. Any part of the portion 302 of the input optical beam 104 not absorbed by one beam dump 116 can be reflected to another beam dump 116. By designing and positioning the beam dumps 116, the portion 302 of the optical beam 104 can undergo multiple bounces, such as three bounces, which allows the vast majority of the optical energy in the portion 302 of the optical beam 104 to be terminated. As a particular example, each of the beam dumps 116 may be able to terminate up to 87% or more of stray optical energy striking that beam dump 116 for each bounce, so a “three bounce” arrangement would be able to terminate up to 99.7% or more of stray optical energy striking the three beam dumps 116. Note that the same process can occur for any portion of an optical beam from a high-reflectance mirror 112 that is transmitted through a dichroic filter 110 (rather than being reflected from the dichroic filter 110).

Although FIG. 3 illustrates one example of a beam dump arrangement in the optical bench 100 of FIGS. 1A and 1B and the compact optical beam combiner package 200 of FIGS. 2A through 2C, various changes may be made to FIG. 3. For example, the total number of beam dumps 116 used here can vary, such as based on the number of input optical beams 104 being combined.

FIG. 4 illustrates an example cross-section of beam dumps 116 in the optical bench 100 of FIGS. 1A and 1B and the compact optical beam combiner package 200 of FIGS. 2A through 2C according to this disclosure. In particular, the cross-section of the beam dumps 116 here is taken horizontally along the central portion of the beam dumps 116 while looking towards the bottoms of the beam dumps 116.

As shown in FIG. 4, each beam dump 116 includes flanges 402, which can extend from the bottom or other portion of a central body 404 of the beam dump 116. Each flange 402 represents a structure that can be connected to the manifold 118, platform 102, or other structure in order to secure the beam dump 116 in place. Note, however, that the flanges 402 are optional and that any other mechanism may be used to hold the beam dump 116 in place.

The central body 404 represents the primary structure of the beam dump 116 used to absorb optical energy. The central body 404 extends upward from the flanges 402 and includes various surfaces that can be struck by optical energy during use of the optical bench 100 or the compact optical beam combiner package 200. The central body 404 in this example has the general form of a rectangular prism. Two major surfaces 406 of the central body 404 (such as the larger surfaces on opposite sides of the central body 404) may be textured, such as when the two major surfaces 406 are grooved. These grooves can help to increase the surface area of each major surface 406 of the central body 404, which provides for greater absorption of optical energy. These grooves can also or alternatively adjust the angle of reflection so that optical energy that is not absorbed by the central body 404 is directed at a sharper angle towards the adjacent beam dump 116. Note that, in this example, the grooves on the two major surfaces 406 of the central body 404 do not have the same size. However, the grooves on the two major surfaces 406 of the central body 404 may have the same size in other embodiments.

In some cases, each beam dump 116 may be actively cooled, such as by using at least one coolant flow through at least the central body 404 of the beam dump 116. For example, the central body 404 of the beam dump 116 may include at least one fluid channel 408, and each fluid channel 408 can be fed a flow of fluid coolant. The fluid coolant can pass through a supply manifold 410 into each fluid channel 408 and can exit each fluid channel 408 into a return manifold 412. Note, however, that any other suitable fluid cooling mechanisms or other cooling mechanisms may be used in or with the beam dumps 116. This disclosure is not limited to any specific active cooling techniques. Also note that active cooling of the beam dumps 116 may not be needed in some embodiments, such as when the power levels of the optical beams 104 are adequately low or the beam dumps 116 absorb adequately low amounts of optical energy.

Although FIG. 4 illustrates one example of a cross-section of beam dumps 116 in the optical bench 100 of FIGS. 1A and 1B and the compact optical beam combiner package 200 of FIGS. 2A through 2C, various changes may be made to FIG. 4. For example, each beam dump 116 may have any other suitable design that terminates optical energy.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 108 (f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 108 (f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
a dichroic combiner array configured to combine multiple input optical beams and generate an output optical beam, the dichroic combiner array comprising:
multiple mirrors; and
multiple dichroic filters;
wherein a first of the mirrors is configured to reflect a first of the input optical beams towards a first of the dichroic filters, the first dichroic filter configured to combine the first input optical beam and a second of the input optical beams;
wherein a second of the mirrors is configured to reflect a combined optical beam from the first dichroic filter to a second of the dichroic filters; and
wherein a last of the dichroic filters is configured to generate the output optical beam; and
a beam dump array comprising multiple beam dumps configured to terminate stray optical energy, the stray optical energy comprising at least one of: (i) optical energy reflecting from at least one of the dichroic filters and (ii) optical energy transmitted through at least one of the dichroic filters.

2. The apparatus of claim 1, wherein:
the dichroic combiner array is configured to receive n input optical beams;
the multiple mirrors comprise a collection of n−1 mirrors;
the multiple dichroic filters comprise a collection of n−1 dichroic filters;
the beam dump array includes n beam dumps; and
the dichroic filters are collectively configured to generate n−1 combined optical beams, a final combined optical beam representing the output optical beam.

3. The apparatus of claim 2, wherein n is an integer equal to at least three.

4. The apparatus of claim 1, further comprising:
a manifold configured to provide at least one fluid coolant to the beam dumps and to receive the at least one fluid coolant from the beam dumps.

5. The apparatus of claim 1, further comprising:
a platform configured to carry the dichroic combiner array and the beam dump array; and
multiple connectors configured to receive the input optical beams.

6. The apparatus of claim 5, wherein the multiple connectors are configured to be coupled to multiple optical fibers.

7. The apparatus of claim 5, further comprising:
a housing configured to receive an optical bench comprising the platform, the dichroic combiner array, and the beam dump array; and
a cover configured to secure the optical bench in the housing.

8. The apparatus of claim 7, further comprising:
an interface plate configured to be connected to the housing and to an external structure;
wherein the interface plate comprises a first port configured to receive at least one fluid coolant and a second port configured to provide the at least one fluid coolant.

9. The apparatus of claim 1, wherein the beam dumps of the beam dump array are arranged to allow the stray optical energy to strike the beam dumps at least three times, the beam dumps configured to absorb portions of the stray optical energy during each strike.

10. The apparatus of claim 9, wherein each beam dump comprises two major surfaces, the major surfaces of each beam dump having grooves.

11. A method comprising:
combining multiple input optical beams using a dichroic combiner array to generate an output optical beam, the dichroic combiner array comprising:
multiple mirrors; and
multiple dichroic filters;
wherein a first of the mirrors reflects a first of the input optical beams towards a first of the dichroic filters and the first dichroic filter combines the first input optical beam and a second of the input optical beams;
wherein a second of the mirrors reflects a combined optical beam from the first dichroic filter to a second of the dichroic filters; and
wherein a last of the dichroic filters generates the output optical beam; and
terminating stray optical energy using a beam dump array comprising multiple beam dumps, the stray optical energy comprising at least one of: (i) optical energy reflecting from at least one of the dichroic filters and (ii) optical energy transmitted through at least one of the dichroic filters.

12. The method of claim 11, wherein:
the dichroic combiner array receives n input optical beams;
the multiple mirrors comprise a collection of n−1 mirrors;
the multiple dichroic filters comprise a collection of n−1 dichroic filters;
the beam dump array includes n beam dumps; and
the dichroic filters collectively generate n−1 combined optical beams, a final combined optical beam representing the output optical beam.

13. The method of claim 11, further comprising:
providing at least one fluid coolant to the beam dumps and receiving the at least one fluid coolant from the beam dumps using a manifold.

14. The method of claim 11, further comprising:
mounting the dichroic combiner array and the beam dump array on a platform; and
using multiple connectors to receive the input optical beams.

15. The method of claim 14, wherein the multiple connectors are configured to be coupled to multiple optical fibers.

16. The method of claim 11, wherein the beam dumps of the beam dump array are arranged to allow the stray optical energy to strike the beam dumps at least three times, the beam dumps configured to absorb portions of the stray optical energy during each strike.

17. A method comprising:
placing an optical bench in a housing; and
securing the optical bench within the housing;
wherein the optical bench comprises:
a dichroic combiner array configured to combine multiple input optical beams and generate an output optical beam, the dichroic combiner array comprising:
multiple mirrors; and
multiple dichroic filters;
wherein a first of the mirrors is configured to reflect a first of the input optical beams towards a first of the dichroic filters, the first dichroic filter configured to combine the first input optical beam and a second of the input optical beams;
wherein a second of the mirrors is configured to reflect a combined optical beam from the first dichroic filter to a second of the dichroic filters; and
wherein a last of the dichroic filters is configured to generate the output optical beam; and
a beam dump array comprising multiple beam dumps configured to terminate stray optical energy, the stray optical energy comprising at least one of: (i) optical energy reflecting from at least one of the dichroic filters and (ii) optical energy transmitted through at least one of the dichroic filters.

18. The method of claim 17, wherein securing the optical bench within the housing comprises:
placing a cover over the optical bench; and
connecting the cover to the housing.

19. The method of claim 17, further comprising:
connecting an interface plate to the housing, the interface plate also configured to be connected to an external structure;
wherein the interface plate comprises a first port configured to receive at least one fluid coolant and a second port configured to provide the at least one fluid coolant.

20. The method of claim 17, wherein the beam dumps of the beam dump array are arranged to allow the stray optical energy to strike the beam dumps at least three times, the beam dumps configured to absorb portions of the stray optical energy during each strike.
